(19) United States
(12) Patent Application Publication
(10) Pub. No.: US 2026/0300461 A1
(43) Pub. Date: Oct. 1, 2026

(54) AI-RESISTANT CAPTCHA USING WATERMARKING AND EXPLAINABILITY

(71) Applicant: Cisco Technology, Inc., San Jose, CA (US)

(72) Inventors: Ashish Kundu, Milpitas, CA (US); Mahesh Viswanathan, White Plains, NY (US)

(73) Assignee: Cisco Technology, Inc., San Jose, CA (US)

(21) Appl. No.: 19/095,684

(22) Filed: Mar. 31, 2025

(51) Int. Cl. G06F 21/36

(52) U.S. Cl. CPC G06F 21/36; G06F 2221/2133

(57) ABSTRACT

In one implementation, a device receives a request from a requester to access a resource. The device provides a challenge to the requester to provide information regarding a watermark embedded into an image. The device receives a response from the requester to the challenge.

The device controls access to the resource by the requester based on the response.

### TECHNICAL FIELD

The present disclosure relates generally to detecting human-originated computing requests and, more particularly, to artificial intelligence (AI)-resistant Completely Automated Public Turing test to tell Computers and Humans Apart (CAPTCHA) using watermarking and explainability.

### BACKGROUND

The recent breakthroughs in large language models (LLMs) and other generative artificial intelligence (AI) represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more generative AI models.

However, as generative AI continues to mature, it also presents new challenges with respect to cybersecurity. More specifically, AI is now capable of automating many tasks typically performed by humans for purposes of data exfiltration, spreading malware, gaining access to secured systems, and the like. To help guard against this, approaches such as Completely Automated Public Turing test to tell Computers and Humans Apart (CAPTCHA) are often employed, to ensure that a protected system is being accessed by a human user. For instance, a simple CAPTCHA may present a set of images as part of a login screen, asking the requester seeking access to identify those images that depict a certain type of object or action (e.g., crosswalks, bicycles, etc.). However, AI is increasingly able to perform CAPTCHA tasks that were once impossible for an AI-based agent to perform versus a human, making certain CAPTCHA techniques ineffective.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of a user interfacing with a language model;

FIG. 4 illustrates an example architecture for an artificial intelligence (AI) agent;

FIGS. 5A-5B illustrate an example of a CAPTCHA deployment;

FIG. 6 illustrates an example of an AI-resistant CAPTCHA system based on explainability; and

FIG. 7 illustrates an example simplified procedure for verifying the humanity of a requester, in accordance with one or more implementations described herein.

### DESCRIPTION OF EXAMPLE IMPLEMENTATIONS

### Overview

According to one or more implementations of the disclosure, a device receives a request from a requester to access a resource. The device provides a challenge to the requester to provide information regarding a watermark embedded into an image. The device receives a response from the requester to the challenge. The device controls access to the resource by the requester based on the response.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

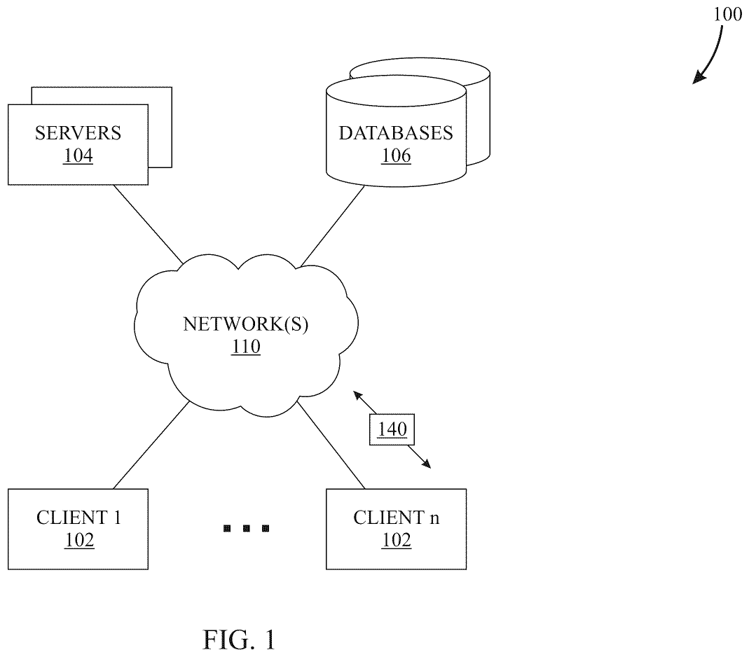

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IOT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (Saas) over a network, such as the Internet.

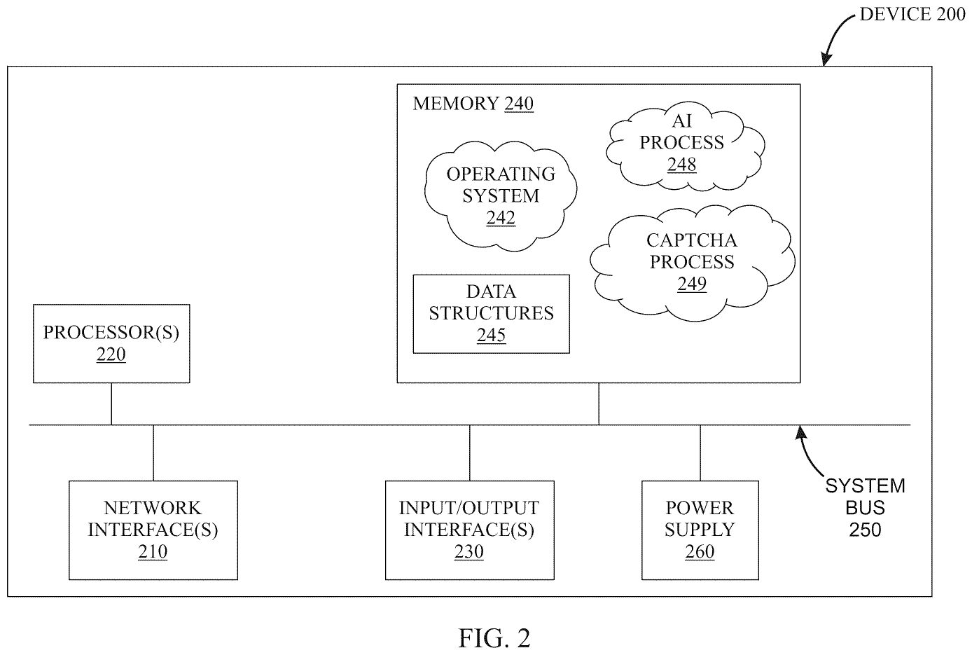

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise an AI process 248 and/or a CAPTCHA process 249, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, AI process 248 and/or CAPTCHA process 249 may include computer executable instructions that, when executed by processor 220, cause device 200 to perform the techniques described herein. To do so, in some implementations, AI process 248 and/or CAPTCHA process 249 may utilize AI/machine learning. In general, AI/machine learning is concerned with the design and the development of techniques that take as input empirical data (such as network statistics and performance indicators) and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, AI process 248 and/or CAPTCHA process 249 may use one or more supervised, unsupervised, or semi-supervised AI/machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels.

Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example AI/machine learning techniques that the AI process 248 and/or CAPTCHA process 249 can use include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, AI process 248 and/or CAPTCHA process 249 may also use one or more generative AI/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, generative adversarial networks (GANs), large language models (LLMs) and other foundation models, diffusion models, transformer models, and the like.

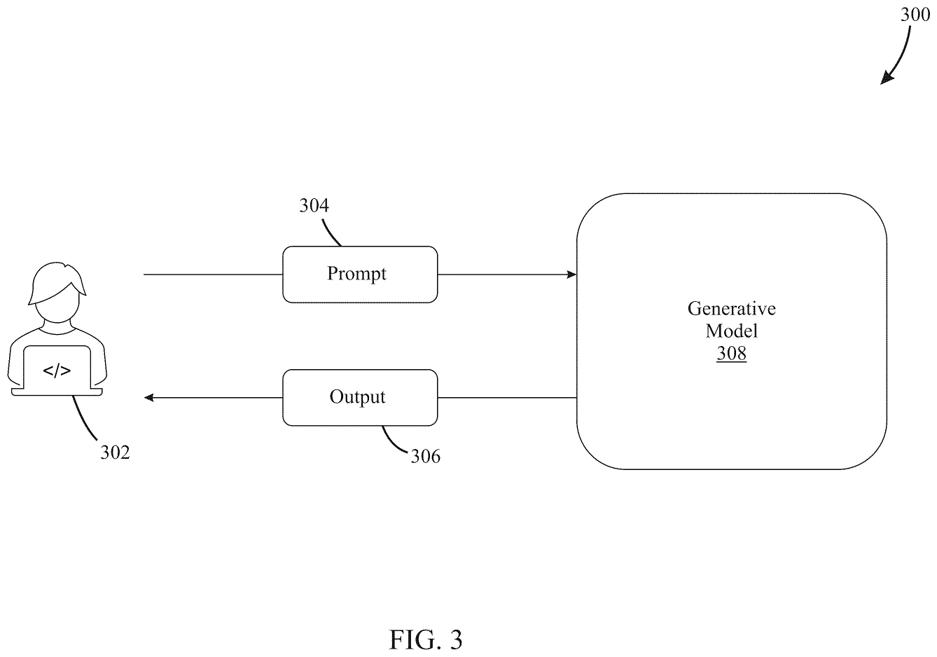

FIG. 3 illustrates an example 300 for interfacing with a language model, in various implementations. In example 300, a user 302 may send a prompt 304 (e.g., a query, a query augmented with additional data, documents, and/or images, etc.) to a generative model 308. The generative model 308 may be configured to process a prompt 304 to generate an output 306 to satisfy the prompt 304.

The generative model 308 may be a model configured to apply its trained algorithms to generate a response (e.g., output 306) based on the prompt 304 provided. For instance, in some cases, generative model 308 may take the form of a large language model (LLM) or other foundation model, diffusion-based model, combinations thereof, or the like.

The output 306 may be the result produced by the generative model 308 (e.g., by the application of the generative model 308 to the prompt 304). This output can vary depending on the model's configuration and the task at hand. For example, the output 306 may include one or more of a generated/synthesized image, a text response, a classification, a prediction, etc.

As noted above, AI agents are also capable of interacting with generative models, such as generative model 308, which may be integrated directly into the agent or accessed via an API. Indeed, the recent breakthroughs in large language models (LLMs), such as GPT-4, as well as other generative models, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

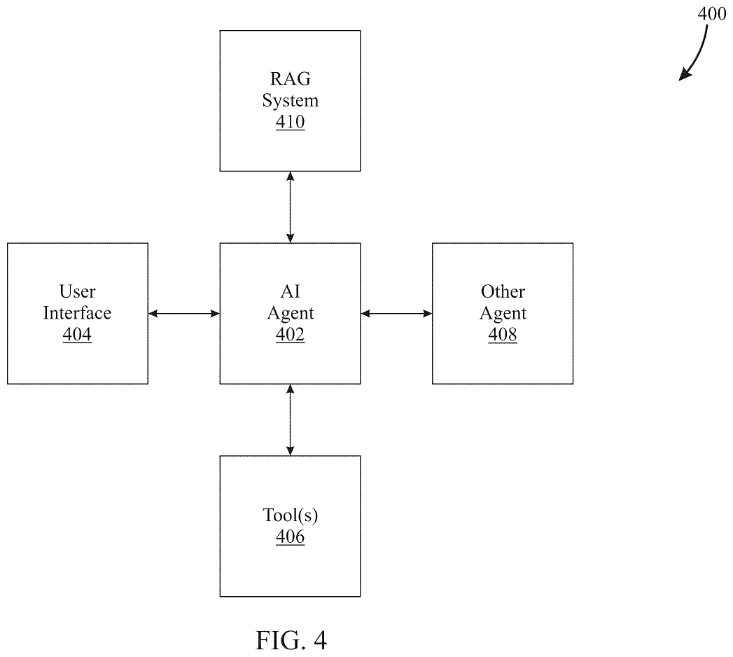

FIG. 4 illustrates an example architecture 400 for an artificial intelligence (AI) agent, according to various implementations. At the core of architecture 400 is AI agent 402, which may be implemented through execution of AI process 248.

As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device execution AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

In some implementations, AI agent 402 may also interact with, or include, a retrieval augmented generation (RAG) system, such as RAG system 410. In general, RAG systems operate by enhancing a prompt for input to a generative model (e.g., an LLM) with additional context. Typically, underlying a RAG system is a dataset of documents or other information that is in a particular domain. For instance, consider the case of AI agent 402 generating a prompt that asks its LLM to make an assessment regarding a computer network. In the case of a general LLM, the LLM may not have specialized knowledge regarding the devices in the network (e.g., command line interface commands, information about the topology of the network, etc.). In such a case, RAG system 410 may modify the prompt, prior to input to the LLM, to provide this additional context, thereby improving the quality of the response and avoiding hallucinations. Typically, a RAG system stores this contextual information in a vector database for quick retrieval using semantic searching.

As noted above, as generative AI continues to mature, it also presents new challenges with respect to cybersecurity. More specifically, generative AI is now capable of automating many tasks typically performed by humans for purposes of data exfiltration, spreading malware, gaining access to secured systems, and the like. To help guard against this, approaches such as Completely Automated Public Turing test to tell Computers and Humans Apart (CAPTCHA) are often employed, to ensure that a protected system is being accessed by a human user. For instance, a simple CAPTCHA may present a set of images as part of a login screen, asking the entity seeking access to identify those images that depict a certain type of object or action (e.g., crosswalks, bicycles, etc.). However, AI is increasingly able to perform CAPTCHA tasks that were once impossible for an AI-based agent to perform versus a human, making certain CAPTCHA techniques ineffective.

### AI-Resistant CAPTCHA Using Watermarking and Explainability

The techniques herein introduce a CAPTCHA system that is resistant to generative AI. In some aspects, the CAPTCHA system may issue certain watermarking tasks that are computationally difficult for AI-based agents to solve versus that of a human user. In further aspects, the CAPTCHA system may also issue explainability problems to requesters, to ensure that the requester seeking access is a human.

Illustratively, the techniques described herein may be performed by hardware, software, and/or firmware, such as in accordance with AI process 248, which may include computer executable instructions executed by the processor 220 (or independent processor of interfaces 210) to perform functions relating to the techniques described herein.

Specifically, according to various implementations, a device receives a request from a requester to access a resource. The device provides a challenge to the requester to provide information regarding a watermark embedded into an image. The device receives a response from the requester to the challenge. The device controls access to the resource by the requester based on the response.

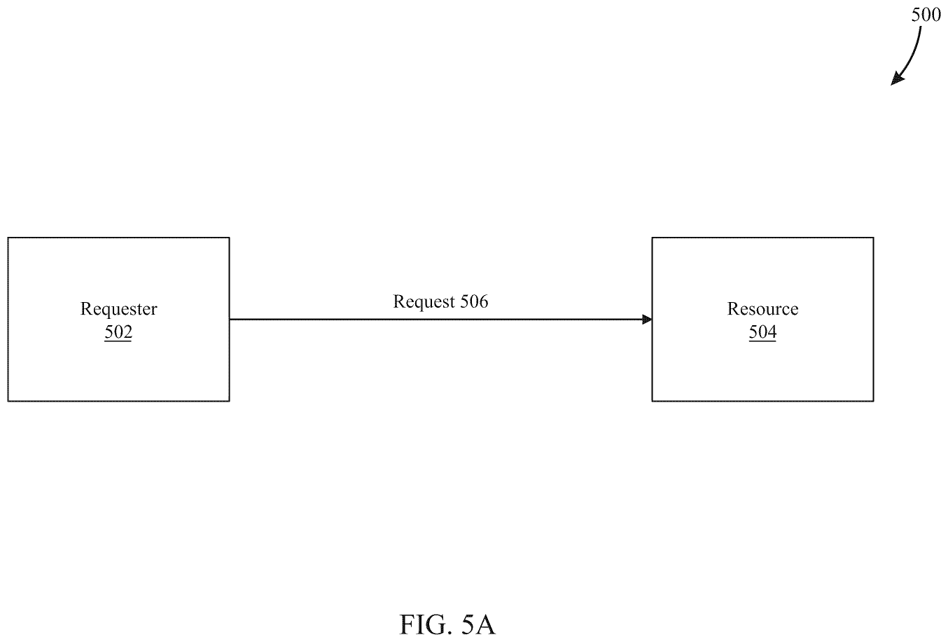

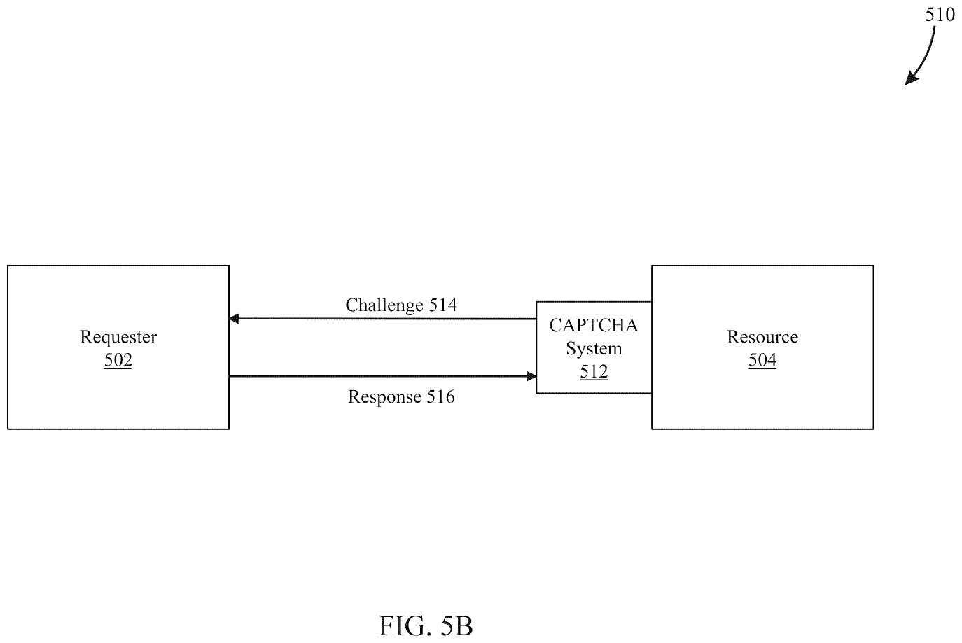

Operationally, FIGS. 5A-5B illustrate an example of a CAPTCHA deployment, according to various implementations. As shown in example 500 in FIG. 5A, assume that there is a requester 502 that issues a request 506 for a resource 504 via a computer network. For instance, request 506 may be a request for a webpage, a login request to access an online application or other system, a database query, or the like.

To protect against bots accessing resource 504, access to resource 504 may be protected by a CAPTCHA system 512, as shown in example 510 in FIG. 5B. In general, the goal of CAPTCHA system 512 is to ensure that requester 502 is a human user and not a bot. To do so, in response to request 506, CAPTCHA system 512 may return a challenge 514 to requester 502 asking requester 502 to perform one or more tasks. For instance, a typical CAPTCHA challenge may entail asking the requester to classify objects, symbols (e.g., distorted letters or numbers), or the like that are depicted in one or more images.

Based on response 516 to challenge 514, CAPTCHA system 512 may determine whether requester 502 is a human user or a computerized entity such as a bot. If requester 502 is indeed a human user, CAPTCHA system 512 may allow resource 504 to process the request 506. Conversely, if CAPTCHA system 512 determines that requester 502 is not a human user, it may indicate that request 506 should be ignored.

In some instances, CAPTCHA system 512 may also take into account a variety of factors, when determining whether requester 502 is a human user. For instance, in addition to the contents of response 516, CAPTCHA system 512 may further take into consideration the amount of time that requester 502 took to return response 516, device information associated with requester 502 (e.g., the IP address or other location information associated with it), any historical behavioral patterns associated with that device, or the like.

Generally, the intuition underlying a CAPTCHA system is that certain tasks are computationally difficult for computing systems and easier for human users. However, as generative AI continues to advance in its capabilities, the threat of requester 502 being an AI-based agent, such as AI agent 402, continues to grow. Indeed, many image classification tasks are now trivial for modern AI models that are capable of processing multimodal inputs (e.g., text, images, etc.), conceptually understanding those inputs, and generating multimodal outputs.

According to various implementations, the techniques herein leverage the fact that certain watermarking tasks are still computationally difficult for AI-based agents versus that of human users. This is because watermarks are subtle and can be made to blend with the background of an image, making it challenging for an AI model to distinguish between the two.

To illustrate the watermarking technique that CAPTCHA system 512 could use, let W be a class of watermarks with the following properties P:
P₁: Watermark w(i,j) is embedded in the i^{th} object o(i), where j≥1. Watermarks can also be fragmented such that watermark w(i,j) has fragments w((i,j),k) where k≥1.
P₂: Automatic detection as to whether o(i) has a watermark w(i,j) or watermark fragment w((i,j),k)) is hard for a computational system that implements automation, such as by using an AI model.
P₃: Manual/human-based detection as to whether o(i) has a watermark w(i,j) or watermark fragment w((i,j),k)) is comparatively easy for humans.

Each watermark and/or its fragment may have verification information that CAPTCHA system 512 could use to verify response 516 from requester 502 in response to a challenge 514 for requester 502 to identify the watermark or watermark fragment of the object (e.g., an object depicted in an image).

In some implementations, CAPTCHA system 512 may send challenge 514 in accordance with the following:
1. Add watermark(s) of class W to an object o or a set of objects depicted in one or more images
2. Include the watermarked image(s) in challenge 514
3. Ask requester 502 to indicate information regarding the included watermark(s) such as any or all of the following:
   a. A description of what the watermark(s) depict—e.g., asking requester 502 to type out the description
   b. The location(s) of the watermark(s)—e.g., asking requester 502 to draw on the watermark using a cursor
c. The features of the watermark(s), such as their coloration(s), shape(s), etc.
d. A validation as to whether the watermark and its verification information provided by CAPTCHA system 512 match

In the case of multiple objects of a set of objects O={o(1), o(2), . . . o(n)}, challenge 514 could likewise request any or all of the following information:
e. a selection of the list of objects where the watermarks are different among each other
f. A selection of the set of objects where the watermarks are similar, same or equivalent, or have some common feature mentioned by challenge 514 or not at all mentioned by challenge 514
g. A selection of one particular object from the set, such as o(2), that contains information d that is in the watermark of another object o(1)

As would be appreciated, watermarks in accordance with the above approach can be used as the first layer or CAPTCHA as an nth layer n≥1 in an authentication or human-centric systems whereby the initial layers use other factors to filter out non-human requesters (e.g., based on location, etc.).

In further implementations, CAPTCHA system 512 may present challenge 514 to a browser or other user interface and ask requester 502 to perform any or all of the following:
a. Describe the watermark—e.g., number of strokes, etc.
b. Find the watermark
c. Click on a certain part of the watermark or the entirety of it
D. Select an option for the watermark
e. Type out the details of the watermark—e.g., what it is, its direction, its color, its location, hot it is, etc.

Further implementations introduced herein leverage the fact that explainability is a harder problem for AI/ML agents and systems than for humans. Generally, explainability relates to asking the user to explain the reason why something happened by presenting the user with a situation, image(s), text, question(s), etc. Since explainability problems are computationally difficult, the techniques herein propose using them for purposes of a CAPTCHA system, such as CAPTCHA system 512, to verify that a requester is indeed human.

More specifically, the techniques herein propose that CAPTCHA system 512 maintains a list L(t) of explainability problems such that they are known at that point of time ‘t’ to be:

### Easy to Be Solved by Humans

hard to be solved by ML systems and agents
has low cognitive load (cl(t))
takes few seconds<n (configurable such as 30 seconds)
can a human user easily recognize an object or analyze a situation

CAPTCHA system 512 then selects a problem from the list randomly such that the problem is not repeated within a given time window. It then creates an instance of the problem using AI or Gen AI (e.g., as an image, text, etc.) and serves the problem to requester 502 via challenge 514 with a time limit n and cognitive load cl(t).

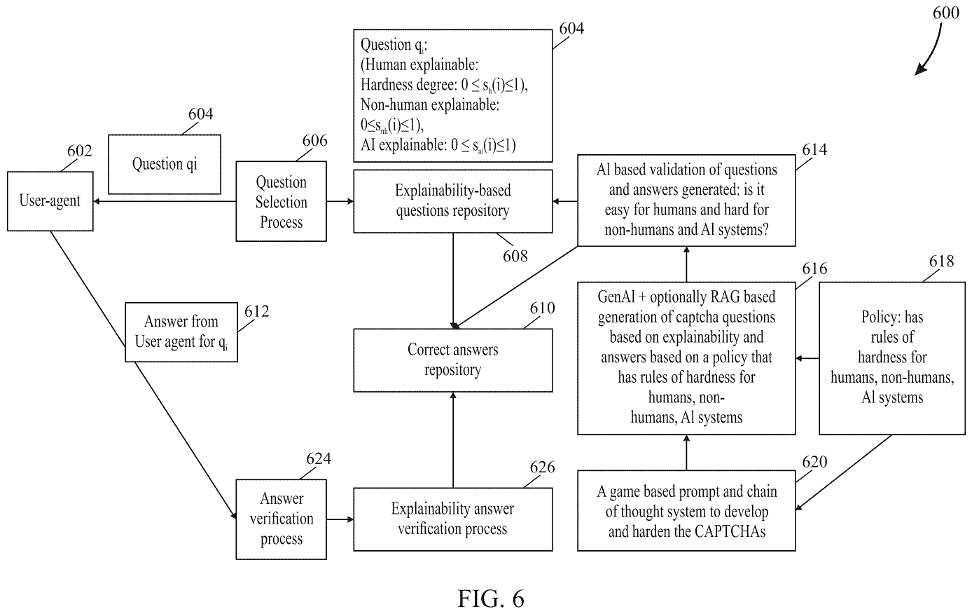

FIG. 6 illustrates an example of an AI-resistant CAPTCHA system based on explainability, according to various implementations. As shown, CAPTCHA system 512 may employ a question selection process 606 that seeks to select and send a question qi, i.e., question 604) to requester 502, such as via a user-agent 602.

In general, question 604 may have three degrees of ‘hardness’:
The degree of hardness for a human to explain, sₕ(i)
The degree of hardness for a non-human to explain, sₙₕ(i)
The degree of hardness for an AI model or agent to explain, sₐᵢ(i)

Here, the degree of hardness for a non-human may correspond to using non-AI based techniques, whereas the degree of hardness for an AI model or agent may be specific to the current state of the art AI models or agents at the time. In some implementations, the degree of hardness may be rated on a scale, such as 0-1 with 0 or 1 indicating the maximum degree of hardness.

The degree of hardness of a given explainability question/problem can also indicate various characteristics of the question/problem, such as how long the different types of requesters are likely to take (e.g., a human vs. an AI model, etc.), whether the different types of requesters are even able to solve it, or the like.

By way of example, question 604 may look similar to any of the following:
“Explain why 9 is different than 3 when using image recognition on images of 9 and 3.”
“Explain what in this image can be modified in order to repair something.”
“Explain how the output can be as it is shown.”

In various implementations, CAPTCHA system 512 may maintain an explainability-based questions repository 608 populated with such questions. In such a case, question selection process 606 (e.g., a sub-component of CAPTCHA process 249) may leverage a table or bipartite graph whereby a vertex represents a question in explainability-based questions repository 608. In such a case, a vertex connected with the requester may represent the degree of hardness for different entities to solve it. Alternatively, the graph could be a n-partite graph, depending on n-types of non-human users to solve it.

In response to receiving an answer 612 to question 604, CAPTCHA system 512 may call an answer verification process 624 and explainability answer verification process 626 (e.g., one or more additional sub-components of CAPTCHA process 249). CAPTCHA system 512 may verify answer 612 using one of several approaches. In one implementation, CAPTCHA system 512 may maintain a repository 610 of correct answers. Such a repository may take the form of a list of semantically equivalent set of solutions, against which CAPTCHA system 512 matches the user-provided solution using a deterministic matching system, a statistical matching system, or a machine learning matching system.

To populate explainability-based questions repository 608 and repository 610 of the correct answers, CAPTCHA system 512 may itself leverage AI. More specifically, as shown, CAPTCHA system 512 may leverage an AI-based system 620 configured to perform a game-based prompt and chain of thought to develop and harden its CAPTCHAs. In such a case, AI-based system 620 may use AI components 616 such as a genAI model and, optionally, RAG, to generate CAPTCHA questions based on explainability and their answers. This can be done in accordance with a policy 618 that specifies the desired degrees of hardness for each entity type.

Once generated, CAPTCHA system 512 may also perform an AI-based validation 614 of the generated questions and answers, to assess whether they are indeed harder for non-humans and AI-based systems to solve relative to a human user. If so, CAPTCHA system 512 may store the generated question in explainability-based questions repository 608 and its answer in repository 610.
By way of example, consider the following CAPTCHA exchange:
Question: “is this digitized, hand-written numeral a ‘9’ or a ‘3’?
Answer: ‘9’
Follow-up question: “Why?”
Follow-up answer: “The vertical line on the right in the ‘9’

Of course, the question and follow-up could also be combined into a singular query, as well. Here, it can be expected that the response will be short (e.g., 4-5 words or fewer). To validate the response, CAPTCHA system 512 may already have a correct answer stored in repository 610. To simplify matching at run-time the answer can be limit to one of four. If the response is semantically close to one of those four responses in the correct answer, then the requester passes that CAPTCHA test.

In some implementations, CAPTCHA system 512 may also vary the semantic match threshold, depending on the nature of resource 504. For instance, CAPTCHA system 512 may require a relatively high semantic match with a correct answer, to access a sensitive resource. Likewise, depending on the sensitivity of resource 504, CAPTCHA system 512 could also increase the complexity of the CAPTCHA challenge, accordingly.

In another example, CAPTCHA system 512 may ask the requester to show why their response is ‘9,’ asking the requester to visually indicate why they selected ‘9.’ In such a case, the requester may circle the portion of the ‘9’ corresponding to its vertical line.

In further cases, CAPTCHA system 512 may ask requester 502 to draw pixels or draw-and-delete pixels to explain their work. For instance, consider the question of “modify 72+9=? so that the answer is 63.” The correct response requires removing the vertical line on the plus sign or circling the vertical to indicate its removal or both editing the image and indicating in words what the user action might be (“remove vertical line on plus sign”). In other words, the explainability problems may require textual explanations, image manipulation, or both from requester 502.

There could be a voice dimension as well, in one implementation. For instance, CAPTCHA system 512 may ask requester 502 to state the answer in spoken language. In such a case, CAPTCHA system 512 may transcribe and compare the answer with the prebuilt correct responses using the same semantic matching approach already discussed.

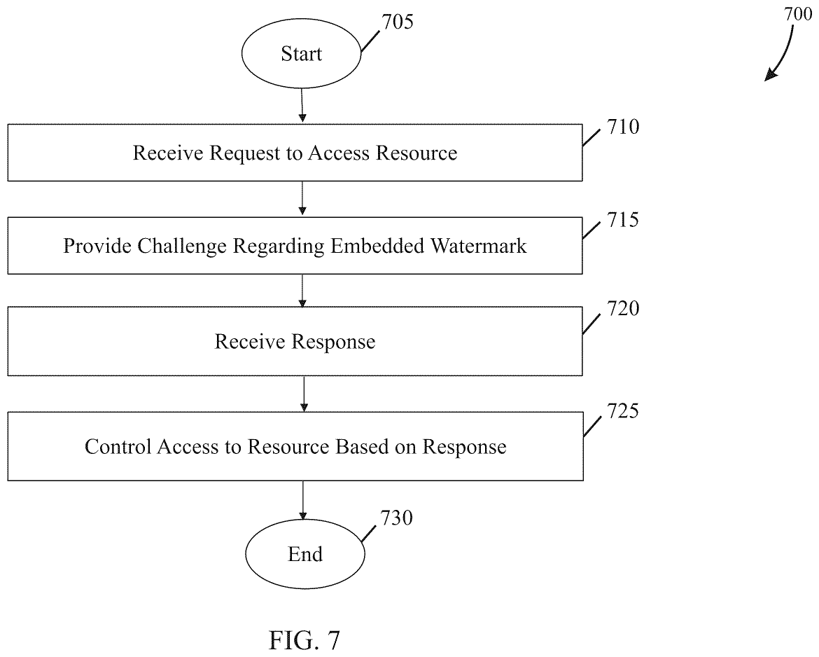

FIG. 7 illustrates an example simplified procedure for verifying the humanity of a requester, in accordance with one or more implementations described herein. For example, a non-generic, specifically configured device (e.g., device 200), may perform procedure 700 (e.g., a method) by executing stored instructions (e.g., CAPTCHA process 249). The procedure 700 may start at step 705, and continues to step 710, where, as described in greater detail above, the device (e.g., a controller, server, etc.) may receive a request from a requester to access a resource. In various instances, the resource comprises a website or online application.

At step 715, as detailed above, the device may provide a challenge to the requester to provide information regarding a watermark embedded into an image. In some implementations, the information regarding the watermark comprises a textual description of the watermark. In one implementation, the device may embed fragments of the watermark into the image at different locations. In some implementations, the device includes in the challenge the image and a plurality of other images each having its own embedded watermark. In such a case, the challenge may ask the requester to select images having similar watermarks. In another implementation, the information regarding the watermark is indicative of a visual characteristic of the watermark. In a further implementation, the information regarding the watermark is indicative of a location of the watermark in the image. In another implementation, the challenge asks the requester to select a particular portion of the watermark.

At step 720, the device may receive a response from the requester to the challenge, as described in greater detail above. In some implementations, the challenge includes an explainability problem. In some cases, the device selects the explainability problem based on a determination that the explainability problem is easier for a human user to solve than for an artificial intelligence model to solve.

At step 725, as detailed above, the device may control access to the resource by the requester based on the response.

Procedure 700 may then end at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for AI-resistant CAPTCHA using watermarking and explainability, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. 1. A method, comprising:
receiving, at a device, a request from a requester to access a resource;
providing, by the device, a challenge to the requester to provide information regarding a watermark embedded into an image;
receiving, at the device, a response from the requester to the challenge; and
controlling, by the device, access to the resource by the requester based on the response.

2. The method as in claim 1, wherein the resource comprises a website or online application.

3. The method as in claim 1, wherein the information regarding the watermark comprises a textual description of the watermark.

4. The method as in claim 1, further comprising:
embedding fragments of the watermark into the image at different locations.

5. The method as in claim 1, wherein the device includes in the challenge the image and a plurality of other images each having its own embedded watermark; and wherein the challenge asks the requester to select images having similar watermarks.

6. The method as in claim 1, wherein the challenge includes an explainability problem.

7. The method as in claim 6, wherein the device selects the explainability problem based on a determination that the explainability problem is easier for a human user to solve than for an artificial intelligence model to solve.

8. The method as in claim 1, wherein the information regarding the watermark is indicative of a visual characteristic of the watermark.

9. The method as in claim 1, wherein the information regarding the watermark is indicative of a location of the watermark in the image.

10. The method as in claim 1, wherein the challenge asks the requester to select a particular portion of the watermark.

11. An apparatus, comprising:
one or more network interfaces;
a processor coupled to the one or more network interfaces and configured to execute one or more processes; and
a memory configured to store a process that is executable by the processor, the process when executed configured to:
receive a request from a requester to access a resource;
provide a challenge to the requester to provide information regarding a watermark embedded into an image;
receive a response from the requester to the challenge; and
control access to the resource by the requester based on the response.

12. The apparatus as in claim 11, wherein the resource comprises a website or online application.

13. The apparatus as in claim 11, wherein the information regarding the watermark comprises a textual description of the watermark.

14. The apparatus as in claim 11, wherein the process when executed is further configured to:
embed fragments of the watermark into the image at different locations.

15. The apparatus as in claim 11, wherein the apparatus includes in the challenge the image and a plurality of other images each having its own embedded watermark; and wherein the challenge asks the requester to select images having similar watermarks.

16. The apparatus as in claim 11, wherein the challenge includes an explainability problem.

17. The apparatus as in claim 16, wherein the apparatus selects the explainability problem based on a determination that the explainability problem is easier for a human user to solve than for an artificial intelligence model to solve.

18. The apparatus as in claim 11, wherein the information regarding the watermark is indicative of a visual characteristic of the watermark.

19. The apparatus as in claim 11, wherein the information regarding the watermark is indicative of a location of the watermark in the image.

20. A tangible, non-transitory, computer-readable medium storing program instructions that cause a device to execute a process comprising:
receiving, at the device, a request from a requester to access a resource;
providing, by the device, a challenge to the requester to provide information regarding a watermark embedded into an image;
receiving, at the device, a response from the requester to the challenge; and
controlling, by the device, access to the resource by the requester based on the response.
